(19) United States
(12) Patent Application Publication
(10) Pub. No.: US 2005/0114170 A1
(43) Pub. Date: May 26, 2005

(54) Remote medical treating method and system with local wireless interface

(76) Inventors: Si-Woo Park, Seoul (KR); Byung-Koo Ahn, Seoul (KR)

Correspondence Address: Finnegan Henderson Farabow;Garrett & Dunner, 1300 I Street NW, Washington, DC, 20005, US

(21) Appl. No.: 10/500,322

(22) PCT Filed: Jan. 8, 2003
(86) PCT No.: PCT/KR03/00025

(30) Foreign Application Priority Data
Jan. 8, 2002 (KR) 10-2002-0000893

(51) Int. Cl. G06F 17/60

(52) U.S. Cl. 705/2

(57) ABSTRACT

The present invention relates to a remote medical system for transmitting medical information to and from the predetermined medical facilities through a wireless network. The remote medical system according to the present invention comprises a medical terminal, having a local wireless interface, for examining a patient and producing medical information, and a wireless terminal, having a local wireless interface for performing a wireless communication with the local wireless interface in medical terminal, for transmitting medical information to the medical facilities and receiving medical treatment from the medical facilities.

### FIELD OF THE INVENTION

The present invention relates to a remote access medical treating method and system for transmitting medical information showing the condition of a user's health to a predetermined medical institution and for providing prescribed treatment information according to the diagnosis of the medical institution to the user by the use of local wireless interfaces.

### BACKGROUND OF THE INVENTION

Until the early 1990's, few people used a computer, and even a fewer number of the computer users knew how to use the Internet as a communication means. To the contrary, currently almost everyone from youth to the elderly can use a computer and even spend more time on the Internet. Popularity of the Internet is due to WWW (World Wide Web) that has been put to practical use.

Up to recently, various services based on WWW such as E-commerce, E-news, HTS (Home Trading System), E-mail, etc., are being provided via Internet. Since all services in the past had to be done offline, the expansion of services now offered on the Internet has become a major business worldwide.

Generally, the Internet is a network for performing data communication between a plurality of unit networks having Internet Protocol (IP) addresses and a plurality of hosts, which are provided in each unit network, having individual IP addresses. This Internet is based on TCP/IP (Transmission Control Protocol/Internet Protocol) and uses LAN (Local Area Network) or PSTN (Public Switched Telephone Network). As just indicated host means a computer having a modem or a computer connected to a phone, and each host can communicate with another host by the use of individual IP addresses.

FIG. 1 is a schematic of a conventional network for accessing Internet. Referring to FIG. 1, in a conventional network for accessing Internet, the wired terminal 10 receives an instruction from a user who wants to get information. On receiving the instruction and IP address from the wired terminal 10, the wired network 12 connects the wired terminal 10 to another terminal via Internet. The gateway 14 converts the instruction and IP address, which are transmitted from the wired network, into a type of data that is used over Internet. In order to execute the instruction transmitted from the gateway 14, Internet 16 mediates the connection to another network. On receiving the instruction of a user through Internet 16, the Web server 18 provides corresponding information. Information exchange between different networks can be accomplished by an Internet Service Provider(ISP) 20. Intranet 22 is connected to Internet 16 through ISP 20 and may have a database 24.

With reference to FIG. 1, the user operates a web browser such as MS Explorer or Netscape in the wired terminal 10. Then, the wired terminal 10 attempts to access a desired network by IP address. This attempt continues to a gateway 14 through the network connected to the wired terminal 10, and ends when the wired terminal 10 accesses Internet 16 by TCP/IP protocol. When Internet access is accomplished, information related to where the user wanted to access is transmitted to the wired terminal 10, and data communication is initiated. At this time, if information that the user wants to receive is located on a database 24 of the other intranet 22, the wired terminal connects to the intranet 22 through ISP 20 and finally accesses information stored in the database 24 of the intranet 22. Through networks having these structures, the user searches information on Internet, (a.k.a., ‘Sea of Information’), and tries to make his own information.

That is, in the past the user had to actually travel somewhere to get information; however, along with the development of the communication technology using Internet, the user can get information via a wired terminal such as PC at home or in the office without leaving.

With regard to health and medical services, recently a remote access style medical service was devised that provides medical consultation to the patient located at a remote place through a wired network. In more detail, after the connection established between the wired terminal such as PC to Internet and URL is inputted, the user accesses a web server that can provide a remote medical consultation. Thereafter, the user inputs the current condition of his health or answers questions through the wired terminal for transmission to the web server. The web server diagnoses the condition of the user's health based on data transmitted from the user and reverts the diagnosis to the user. Accordingly, the user can then be confident of the validity of the diagnosis and accordingly seek necessary treatment or be treated at the hospital.

However, there is no function to check the condition of the user's health via the conventional wired terminal, and as a result, the user has to manually input the condition of his health. Generally since the user has little medical knowledge, he cannot receive a proper medical examination with corresponding diagnosis. Furthermore, the wired network for accessing Internet cannot provide mobility to the terminal, so the user is restricted to using this service at the place where the wired terminal connected to Internet is located. Thus, if the user is quite mobile, travels frequently, or is outside, the condition of the user's health cannot be examined properly. Even more problematical, if the user catches an acute disease suddenly, the user cannot receive the immediate first aid required to treat the disease effectively.

Fortunately, due to the development of information communication and the electronic industry, new mobile Internet technology has recently been introduced that allows portable computers and mobile terminal to use existing IP addresses and provides Internet access service to mobile users.

Moreover, in contrast to the original-style computer system limited to home or office use, a wireless network for portable communication system such as PDA (Personal Digital Assistants), cellular phone or IMT2000 (International Mobile Telecommunication 2000) is now available. As a result, the user can use mobile wireless Internet even through portable communication system.

FIG. 2 is a schematic of conventional Internet service system using wireless network. Referring to FIG. 2, the wireless terminal 30 in the conventional mobile Internet service system receives instructions through an external input device such as a keypad or a touch screen, and converts the instruction into an RF signal to transmit. The base station (BS) 32 demodulates the RF signal received from the wireless terminal 30. The wireless network 34 outputs both the instruction and identification (ID) number of the wireless terminal 30 by the use of a protocol for wireless Internet service. The gateway 36 receives the protocol signal for wireless Internet service from the wireless network 34 and converts it into a protocol suitable to Internet access such as TCP/IP. According to the instruction from the gateway 36, Internet 38 mediates each network to be connected. The web server 40 receives the instruction through Internet 38 and transmits web information corresponding to the instruction to the wireless terminal 30. According to the instruction through Internet 38, the ISP 42 connects the wireless terminal to another network.

In the aforementioned mobile Internet service structure, the gateway 36 has a function to convert conventional HTML (Hyper-Text Markup Language) into a script such as HDML (Handheld Device Markup Language), WML (Wireless Markup Language) or mHTML (mobility Hyper Text Markup Language), which is used in a pager, PDA or cellular phone. The Korean domestic telecom service providers such as Sunkyung Telecom (SKT), KTFreetel (KTF), and Lucky-Goldstar Telecom (LGT) currently have or are preparing these gateway servers to provide mobile Internet service to subscribers. As stated, now the user can undertake wireless communicate by means of wireless terminal, so that the user can communicate with other people within the country or internationally.

Various remote access medical methods using a wireless network have been introduced. Hereinafter, representative remote-style medical methods and systems will be described with examples. ‘Medical system using PDA’ comprises a PDA including a wireless modem and a hospital server for transmitting a patient's file history stored in a database as a response to the request from the PDA. Thus, by inputting personal information to the PDA, the patient's file history stored in the hospital server is updated. However, since the doctor has to input the patient's condition information through PDA, it is difficult for the patient to use it. That is, it is difficult for the patient who has no medical knowledge to determine his own health condition.

Secondly, ‘A method for collecting remote medical information through a portable terminal and a wired/wireless Internet unification server’ transmits questions from a medical institution or an emergency center to the user's portable terminal, and then the results corresponding to the questions will be retransmitted to the server when the user inputs the answers to the questions by means of a portable terminal. However, this method can be utilized only for collecting information based on specific medical questions, so it is still impossible to determine the condition of the user's health.

Thirdly, ‘A remote medical system and method in vehicle’ comprises a medical information analyzing part and a vehicle information processing part, both mounted on the vehicle, and a ground medical part for prescribing treatment for the condition of the patient. The medical information analyzing part detects the condition of the patient in the vehicle to transmit information of the patient's condition to the ground medical part, and thereafter the prescription produced by the ground medical part is provided to the vehicle information processing part. This system and method is only effective when the patient is in a vehicle having medical information analyzing equipment and a vehicle information processing equipment. However, when the patient becomes ill in his daily routine, first aid normally cannot be provided immediately causing the patient to suffer from the illness for an extended period.

Based on the faults of the prior inventions, a method using a wireless portable terminal that has functions to examine the condition of the patient's health and a wireless communication has been introduced. Since this wireless medical terminal has both medical examination and wireless communication functions, the cost is of course relatively high.

### DISCLOSURE OF THE INVENTION

The present invention is for overcoming the aforementioned problems of the prior art. The primary object of the present invention is to provide a remote access medical method and system, which by using a wireless terminal having both a local wireless terminal and a portable medical terminal having a function of communicating with the wireless terminal, that can examine the condition of the user's health even though he is mobile and provide a medical diagnosis.

To achieve aforementioned object, according to the preferred embodiment of the present invention, there is provided a medical terminal in a portable medical system that communicates medical information between a wireless terminal and said medical terminal, said medical terminal comprising: a condition examining part for examining a condition of user's health; a medical information converting part for converting condition information produced by said condition examining part into medical information that can be perceived by the outside world; a local wireless interface for medical terminal for transmitting medical information to the local wireless interface of the wireless terminal, such that the medical information is transmitted to a medical institution and a medical result information is transmitted from the medical institution; and a controlling part for controlling operations of said condition examining part, said medical information converting part, and said local wireless interface for medical terminal.

The local wireless interfaces with the wireless terminal, and said medical terminal is one selected from a group consisting of BlueTooth, IEEE 802.11, IrDA, and Home RF. The condition examining part is one selected from a group consisting of a blood pressure monitor, a thermometer, a heart rate monitor, a diabetes monitor, a blood flow monitor, a blood glucose monitor, and an atmosphere monitor.

According to another preferred embodiment of the present invention, a wireless terminal for remote access examination in a portable medical system that communicates medical information between said wireless terminal and a medical terminal, said wireless terminal comprising: an input part for receiving information from a user; an output part for displaying selected information to be perceived by the user; a local wireless interface for wireless terminal to receive medical information via a local wireless interface for the portable medical system; an RF converting part for converting medical information into an RF signal for wireless communication; an RF transducer for transmitting the RF signal to a predetermined medical institution and for receiving medical result information from the medical institution; a memory for storing selected information; and a controlling part for controlling operations of said input part, said output part, said local wireless interface for wireless terminal, and said RF transducer.

According to another preferred embodiment of the present invention, a remote medical system comprising: a medical terminal for examining a condition of user's health to produce medical information; and a wireless terminal for transmitting medical information received from said medical terminal to a predetermined medical institution and for receiving medical result information from the medical institution, wherein said medical terminal comprises: a condition examining part for examining the condition of user's health; a medical information converting part for converting condition information produced by said condition examining part into medical information that can be perceived by the outside world; a local wireless interface for medical terminal for transmitting medical information to the local wireless interface of the wireless terminal, such that medical information is transmitted to a medical institution and medical result information is transmitted from the medical institution; and a controlling part for controlling operations of said condition examining part, said medical information converting part, and said local wireless interface for medical terminal, wherein said wireless terminal comprises: an input part for receiving information from the user; an output part for displaying selected information to be perceived by the user; a local wireless interface for wireless terminal to receive medical information via a local wireless interface for the portable medical system; an RF converting part for converting medical information into an RF signal for wireless communication; an RF transducer for transmitting the RF signal to the medical institution and for receiving medical result information from the medical institution; a memory for storing selected information; and a controlling part for controlling operations of said input part, said output part, said local wireless interface for wireless terminal, and said RF transducer.

According to another preferred embodiment of the present invention, a method for processing medical information by using a wireless terminal and a medical terminal both having local wireless interfaces, said method comprising the steps of: examining a condition of user's health; converting condition information related to the condition of user's health into medical information that can be perceived by the outside world; and transmitting the medical information to the local wireless interface for wireless terminal through the local wireless interface for medical terminal for the purpose of transmitting the medical information from the wireless terminal to a predetermined medical institution and receiving medical result information from the medical institution.

According to another preferred embodiment of the present invention, a method for processing medical information by using a wireless terminal and a medical terminal both having local wireless interfaces, said method comprising the steps of: receiving medical information provided through a local wireless interface for medical terminal; converting medical information into an RF signal for wireless communication; transmitting the RF signal to a predetermined medical institution through a wireless network; and displaying medical result information received from the medical institution for a user to perceive.

According to another preferred embodiment of the present invention, a method for processing medical information in a remote access medical system provided with a wireless terminal and a medical terminal both having local wireless interfaces, said method comprising the steps of: examining a condition of user's health; converting condition information related to the condition of user's health into medical information that can be perceived by the outside world; transmitting medical information to the local wireless interface for wireless terminal through the local wireless interface for medical terminal for the purpose of transmitting medical information from the wireless terminal to a predetermined medical institution and receiving medical result information from the medical institution; receiving medical information provided through a local wireless interface for medical terminal; converting medical information into an RF signal for wireless communication; transmitting the RF signal to a predetermined medical institution through a wireless network; and displaying the medical result information received from the medical institution for a user to perceive.

### BRIEF DESCRIPTION OF THE DRAWINGS

FIG. 1 is a schematic of a conventional network for accessing Internet.

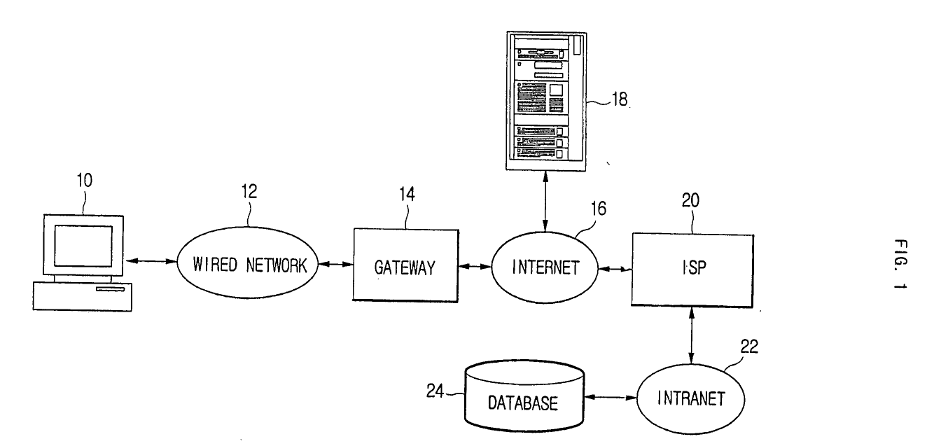

FIG. 2 is a schematic of conventional Internet service system using wireless network.

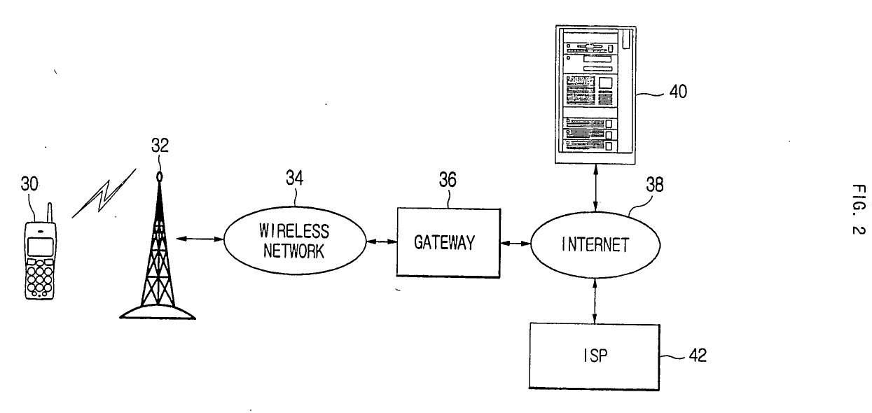

FIG. 3 is a block diagram of a remote medical system in accordance with the preferred embodiment of the present invention.

FIG. 4 is a schematic of general BlueTooth system.

FIG. 5 is a schematic of the wireless terminal having the local wireless interface in the remote medical system in accordance with the preferred embodiment of the present invention.

FIG. 6 is a schematic of the portable medical terminal having the local wireless interface in the remote medical system in accordance with the preferred embodiment of the present invention.

FIG. 7 is a detailed block diagram of the bodily condition examining part in the remote medical system in accordance with the preferred embodiment of the present invention.

FIG. 8 is a data format of medical information to be transmitted from the portable medical terminal to the wireless terminal in the remote medical system in accordance with the preferred embodiment of the present invention.

FIG. 9 is a block diagram showing the coupling relationship between the wireless terminal and the portable medical terminal in the remote medical system in accordance with the preferred embodiment of the present invention.

FIG. 10 is a flowchart showing the remote medical method in accordance with the preferred embodiment of the present invention.

<A list of the reference numbers identifying major parts shown in the drawings>
100: user system
32: base station
34: wireless network
200: server at medical institution
102: RF transducer
104: RF converting part
106, 144: controlling part
108, 146: memory
110, 148: input device
112, 152: output device
114, 154: local wireless interface
120: wireless terminal
130: condition examining part
142: medical information converting part
150: portable medical terminal
131: blood pressure monitor
132: thermometer
133: heart rate monitor
134: diabetes monitor
135: atmosphere monitor
136: blood flow monitor

### DETAILED DESCRIPTION OF THE PREFERRED EMBODIMENTS

Hereinafter, the preferred embodiment of the present invention will be described with accompanying drawings.

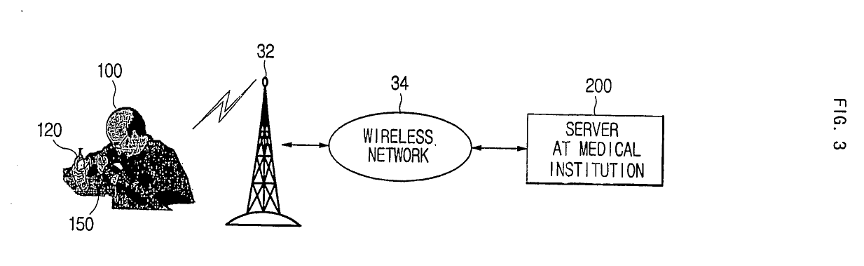

FIG. 3 is a block diagram of a remote access medical system in accordance with the preferred embodiment of the present invention. Referring to FIG. 3, in the remote access medical system in accordance with the present invention, a user system 100 is provided with a wireless terminal 120 having a local wireless interface and a portable medical terminal 150, which can perform a wireless communication with the wireless terminal 120. The wireless terminal 120 and the portable medical terminal 150, for the purpose of local wireless communication, are provided with local wireless interfaces.

The local wireless interface can be one selected from a group consisting of BlueTooth, IEEE 802.11, Home RF and IrDA. Among these interfaces, BlueTooth has been widely used in portable communication devices for various reasons. That is, it is possible to mass-produce BlueTooth interface, and according to this also possible to easily mount BlueTooth interface on the portable communication device. Thus, many phone makers have adopted BlueTooth. Also, because BlueTooth uses the 2.4 GHz ISM (Industrial Scientific Medical) frequency that does not require prior permission, it is possible to manufacture a transmitter module that can be used world-wide. Also, because BlueTooth interface can be manufactured in the form of one chip by use of CMOS (Complementary Metal Oxide Semiconductor) LSI (Large Scale Integration), the manufacturing cost is very low. In addition, when the transmission range is limited to 10 meter, a powerful amplifier is not needed. Accordingly, a minimum receiving sensibility in 10 meter is relatively high −70 dBm. These reasons are all plausible why BlueTooth is widely being used. If no description is provided hereinafter, we will actually be describing a local wireless interface like BlueTooth.

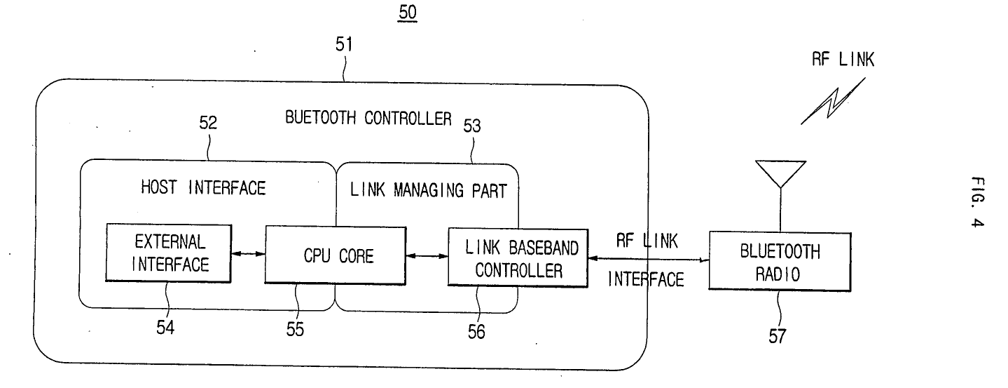

FIG. 4 is a schematic of a general BlueTooth system. Referring to FIG. 4, BlueTooth system 50 is provided with a BlueTooth radio 57 as an analog part and a BlueTooth controller 57 as a digital part. The BlueTooth controller 51 is provided with a link baseband controller 56 as a digital signal processing part, a CPU core 55, and an external interface 54 for connection to the host environment. Thus, the interface between the CPU core 55 and the host environment can be accomplished through the external interface 54, whereas the interface between CPU core 55 and the BlueTooth radio 57 can be accomplished through the link baseband controller 56 by means of RF signal. At this time, in order to minimize interrupting the load of the computer system as a host, it is preferable to use another CPU core 55 to manage BlueTooth. Also, as a consequence of using the BlueTooth controller 51, the power consumed by the main CPU can be reduced and filtering for a PAGE REQUEST can be performed. The BlueTooth controller 51 is programmed to answer a BlueTooth page message, acknowledge a remote link, and operate the main CPU as the occasion demands. Also, the BlueTooth controller 51 can process some tasks of an application level.

Therefore, the portable medical terminal mounted on a user examines the condition of the user's health or the environmental condition, and then transmits this medical information to the wireless terminal by means of BlueTooth system. The wireless terminal receives the medical information by means of BlueTooth system including the portable medical terminal, and according to the set up conditions, transmits medical information to a server 200 at a predetermined medical institution via the base station 32 and the wireless network 34. At this time, the portable medical terminal can display the examination results pertaining to the condition of the user's health or the medical results due to the environmental conditions on a screen, such that the user can perceive these results. According to the examination results produced by the portable medical terminal, a reference value for issuing an alert regarding the condition of his health back to the user can be established. For example, it can be established that whenever the medical results exceed the acceptable reference values for current health conditions regarding blood pressure, body temperature, heart rate, and atmospheric conditions, etc., the user will be notified of the discrepancies. Also, the user can establish the wireless terminal to automatically transmit medical information to server 200 at the medical institution or to display medical information before transmission when medical information is transmitted from the portable medical terminal.

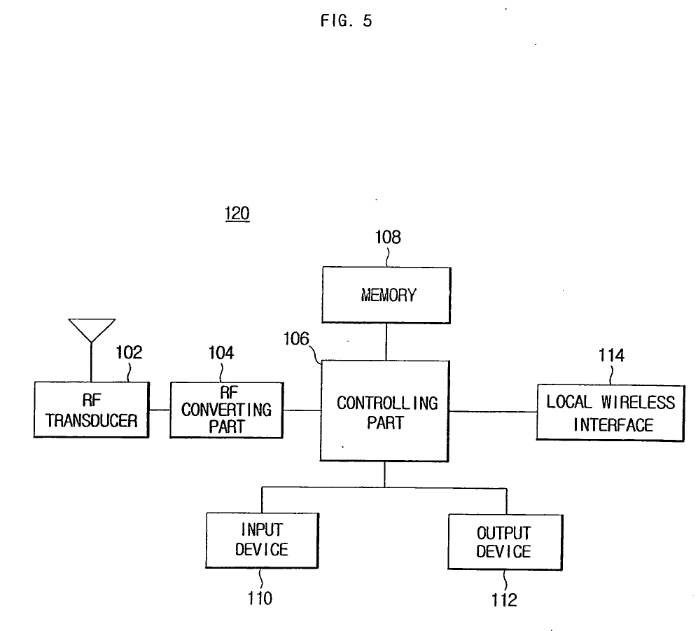

FIG. 5 is a schematic of the wireless terminal having the local wireless interface in the remote access medical system in accordance with the preferred embodiment of the present invention. Referring to FIG. 5, the wireless terminal 120 is provided with a memory 108, at least one controlling part 106 that operates at high speed with a connection to the memory, an input device 110, an output device 112, an RF converting part 104 that converts information to be transmitted into an RF signal, an RF transducer 102 that transmits and receives RF signals via wireless network, and a local wireless interface 114 that performs a local wireless communication with the portable medical terminal. The local wireless interface 114 is one part of BlueTooth system that comprises the local wireless interface 114 in portable medical terminal 120 and the local wireless interface 154 in the mobile terminal 150 and furthermore receives medical information from the portable medical terminal by means of a predetermined carrier frequency or a distinguishable code.

The controlling part 106 may include an ALU (Arithmetic Logic Unit) that performs a calculation, a register that stores data and instructions temporarily, and a controller that controls the operations of the wireless terminal 120. The controlling part 106 can be a processor based on various constructions such as Alpha of Digital, Inc., MIPS of MIPS Technologies, NEC, IDT and Siemens Corp., x86 of Intel, Cyrix, AMD and Nexgen, and PowerPC of IBM and Motorola.

The memory 108 comprises a high-speed main memory such as RAM and ROM, a supplementary memory such as flash memory that can store data long term, and a storage device that can store data on an electrical, magnetic or optic medium. Also, the main memory may include a video display memory for displaying images on a display monitor or device. It is apparent to those who are skilled in the art that the memory 108 can be implemented by various forms. Also, the input device 110 and the output device 112 can be conventional input devices and output devices. The input device 110 may be a physical transducer including, for example, a touch screen, a pointing device, or microphone. The output device 112 may be a transducer such as a display or speaker, etc. Also, a network interface or modem can be used as an input/output device.

In the field of the present invention, the wireless terminal 120 may include an OS (Operating system) and at least one application program. OS is a collection of software for controlling the operations of the wireless terminal 120 and assignments of resources. The application program is a collection of software for performing a task requested from a user by using available computer resources through OS. OS and the application program may be stored on memory 108 permanently. According to the experience of those who are skilled in computer programming, the present invention will be described with operations performed by the wireless terminal 120 and symbols representing the operations. These operations are based on computer technology and may be performed by OS or proper application programs. Also, these operations and functions include handling the controlling part 106 on data bits causing conversion or interruption of electrical signals and managing data bit stored on the memory 108 as well as an alteration in the operation of the wireless terminal 120. The memory part that manages the data bit signals corresponds to a physical part having electrical, magnetic or optical characteristics.

The RF converting part 104 converts a voice signal, a text signal or medical information transmitted from the portable medical terminal into RF signal for communicating with BS 32, or converts the RF signal received from BS 32 into a signal that can be processed by the wireless terminal. In order to provide medical information to the server 200 at the predetermined medical institution, the RF transducer 102 transmits medical information, which is converted by RF converting part 104, to BS 32. Accordingly, the service 200 receives medical information related to the condition of user's health from the portable medical terminal 130 and the wireless terminal 120, and diagnoses the user's health. Then, the server 200 provides the diagnosis of health of the user or the prescription corresponding to treating the condition of health by transmitting the medical results to the wireless terminal 120. Also, the current location of the user can be acquired from the RF signal transmitted from the user's wireless terminal. Thus, the server 200 can prescribe a remedy depending on the user's position as well as the condition of user's health and atmospheric condition.

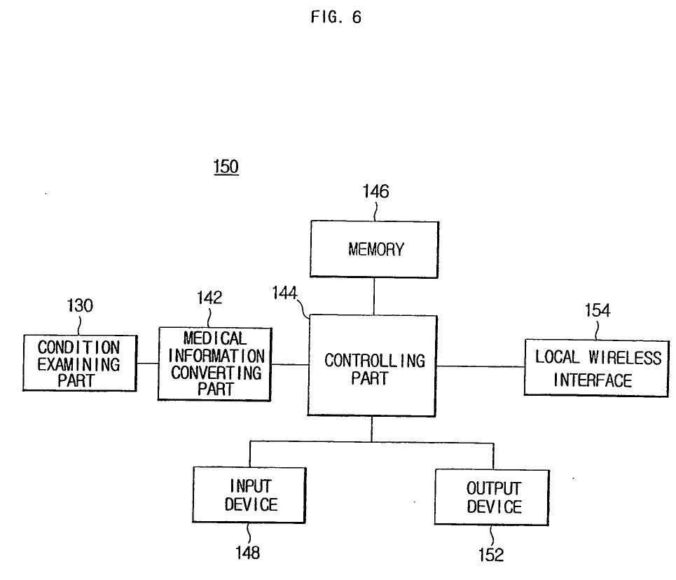

FIG. 6 is a schematic of the portable medical terminal having the local wireless interface in the remote access medical system in accordance with the preferred embodiment of the present invention. Referring to FIG. 6, the portable medical terminal is provided with a memory 146, at least one controlling part 144 that operates at high speed with connection to the memory, an input device 148, an output device 152, a condition examining part 130 for examining the bodily condition of user's health, a medical information converting part 142 for converting medical information examination results into a signal to be perceived by the user, and a local wireless interface 154 for local wireless communication with the wireless terminal.

The memory 146, the controlling part 144, the input device 148, and the output device 152 are constructed similarly respective to the memory 108, the controlling part 106, the input device 110, and the output device 112 of the wireless terminal 120. The condition examining part 130 examines the condition of the user's health or the atmospheric conditions around or apart from the user.

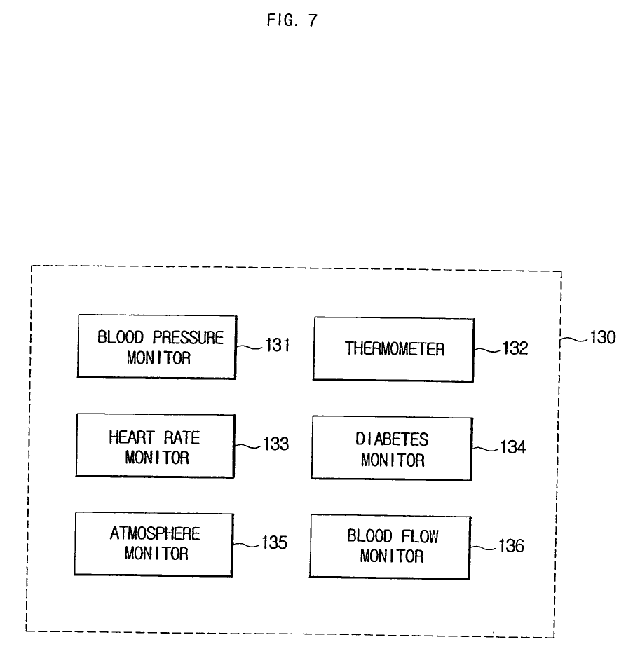

FIG. 7 is a detailed block diagram of the condition examining part in the remote access medical system in accordance with the preferred embodiment of the present invention. Referring to FIG. 7, the condition examining part 130 is provided with one part for examining the condition of the user's health and another part for examining the atmospheric conditions at the location of the user. The part for examining the condition of user's health may comprise a blood pressure monitor 131, a thermometer 132, a heart rate monitor 133, diabetes monitor 134, or a blood flow monitor 136. The blood pressure monitor 131 measures the pressure of blood running through an artery or a vein, while a thermometer 132 measures the temperature of the user. The heart rate monitor 133 measures the number of heart beats per unit of time detected through the artery or the vein and the diabetes monitor 134 measures the density of blood glucose by use of humors come from the user's skin. Also, the blood flow monitor 136 measures the amount of blood flow per unit dimension, which runs through the artery or the vein. The bodily functions to be examined are not limited to the aforementioned but may vary according to the specificity of the examination, and the measuring methods corresponding to each bodily function may be performed by various medical methods. The atmosphere monitor 135 can measure the temperature or humidity of the place where the user is located, and also measure the density of carbon monoxide or carbon dioxide in the atmosphere.

Thus, it is possible to determine whether or not a correlation exists between the condition of the user's health and the current atmosphere condition. In particular, by manipulating the controlling part 144 through the input device 148, the user may establish a reference value for issuing a medical alert according to his current condition of health or the atmospheric condition. That is, it is possible to establish a threshold value for each of the blood pressure, the temperature, the heart rate, diabetes or the blood flow, and then to issue a medical alert message by sound or image when post-examination values of the user exceed the threshold value. The aforementioned procedure may also be applied acceptable atmospheric conditions compared with those of the user's current location.

The medical information converting part 142 converts medical information showing the condition of the user's health or the atmospheric condition measured by the condition examining part 130 into a text or a voice message to be perceived by the user. The text message or the voice message may be displayed to the user through the output device 152. Also, medical information may be transmitted to the wireless terminal 120 through the local wireless interface 154, and then transmitted to the server 200 at the predetermined medical institution.

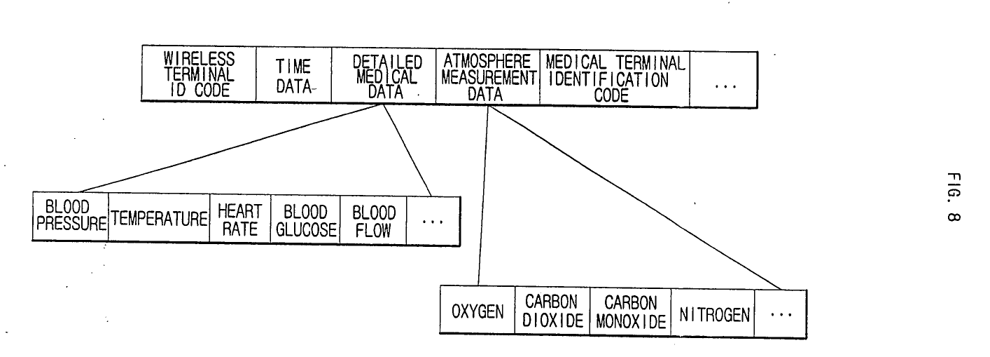

FIG. 8 is a data format of medical information to be transmitted from the portable medical terminal to the wireless terminal in the remote access medical system in accordance with the preferred embodiment of the present invention. Referring to FIG. 8, medical information to be transmitted from the portable medical terminal to the wireless terminal may comprise a wireless terminal identification code, time data, detailed medical data relating to the condition of the user's health, atmosphere measurement data, and a medical terminal identification code.

The wireless terminal identification code differentiates the wireless terminal that has transmitted to the medical terminal and transmits medical information to the designated wireless terminal. Accordingly, the wireless terminal identification code may be comprised of a code number or a carrier frequency to differentiate the wireless terminal. Time data is for indicating when the condition of user's health is measured. Detailed medical data is for indicating the condition of user's health, and more particularly, relates to the blood pressure, the temperature, the heart rate, the blood glucose, and the blood flow. These detailed medical data may include an identification code, respectively. Atmosphere measurement data for indicating the atmosphere condition of the user's location may include information on the amounts of oxygen, carbon dioxide, carbon monoxide, nitrogen, etc. Of course it should be apparent that atmosphere measurement data is not limited to the aforementioned criteria but may include further information of other atmospheric components related to the condition of the user's health. The medical terminal identification code for discriminating the medical terminal that transmits medical information may be, the same as the wireless terminal identification code, comprised of a code number or a carrier frequency. Especially, if the user uses a plurality of medical terminals or there is a plurality of terminals that communicate with the wireless terminal, the medical terminal identification code may be used.

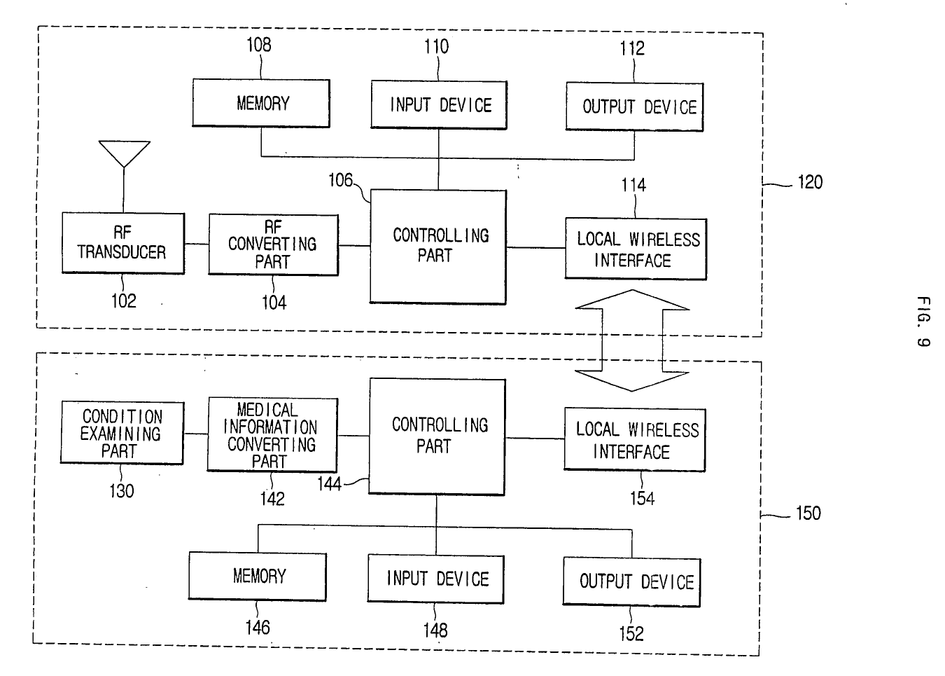

FIG. 9 is a block diagram showing the coupling relationship between the wireless terminal and the portable medical terminal in the remote medical system in accordance with the preferred embodiment of the present invention. Referring to FIG. 9, the wireless communication between the wireless terminal 120 and the portable medical terminal 150 is performed through the local wireless interfaces 114, 154. When wireless communication is initiated by the use of the identification code or the carrier frequency, the local wireless interfaces 114, 154 preferably use the BlueTooth system rather than IrDA, IEEE 802.11 or Home RF.

Accordingly, medical information related to the condition of user's health or the atmosphere measured by the condition examining part 130 in the portable medical terminal 150 is converted at the medical information converting part 142 to be transmitted to the wireless terminal 120 through the local wireless interface 154. The wireless terminal 120 converts medical information into the RF signal at the RF converting part 104 to be transmitted to the server 200 at the predetermined medical institution. Also medical results that are produced by the server 200 based on medical information are then provided to the user through the wireless terminal 120. Thus, the medical result information is provided to the user through the wireless terminal 120 or the portable medical terminal 150.

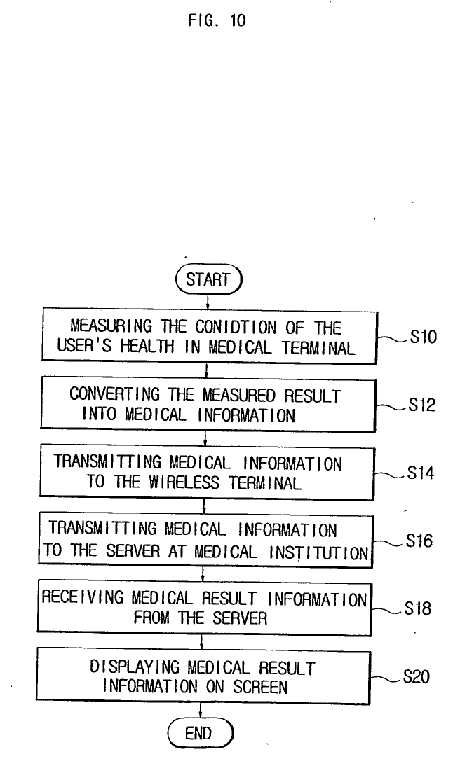

FIG. 10 is a flowchart showing the steps undertaken for the remote access medical method in accordance with the preferred embodiment of the present invention. Referring to FIG. 10, the condition of the user's health or his surrounding atmospheric condition is measured by the portable medical terminal located on or apart from the user (S10). Information related to the condition of the user's health or the atmosphere is converted into medical information to be perceived by the user (S12). This medical information is transmitted to the wireless terminal through the local wireless interface (S14), e.g, BlueTooth system. Then, the medical information is transmitted to the server at the predetermined medical institution through the wireless terminal (S16). The server receives the medical information provided from the wireless terminal and produces medical result information including the current diagnosis of the user's health and a corresponding prescription based on medical information to treat the user. Medical result information is transmitted to the wireless terminal (S18), and the user can see the medical result information displayed on the wireless terminal or the portable medical terminal (S20). Thus, according to medical result information, the user can conduct a pertinent medical treatment.

Industrial Applicability

As just explained in detail, according to the remote access medical method and system, the user uses the portable medical terminal having the local wireless interface to measure the condition of the user's health or the atmosphere condition even while the user is currently mobile or at any place without medical staff. Regardless, appropriate first aid can be given to the user as prescribed. In particular, the wireless terminal and the medical terminal both having local wireless interfaces communicate with each other, such that remote access medical examination and treatment can be effectively provided to the user by the use of a low-cost medical terminal. Finally, since the wireless terminal performs wireless communication, it is easy to find the user's physical location, and as a result, prescribed medical treatment depending on the user's position can be instructed.

Although the present invention has been described with the preferred embodiment, the spirit and the scope of the present invention will be determined only by the following claims. Also, it will be apparent for those skilled in the art that modifications or amendments to the aforementioned embodiment within the spirit and the scope of the present invention are possible without departing from the boundary of the claimed invention.

1. A medical terminal in a portable medical system that communicates medical information between a wireless terminal and said medical terminal by wireless, said medical terminal comprising:
a condition examining part for examining a condition of user's health;
a medical information converting part for converting condition information produced by said condition examining part into medical information that can be perceived by the outside world;
a local wireless interface for medical terminal for transmitting medical information to the local wireless interface of the wireless terminal, such that the medical information is transmitted to a medical institution and a medical result information is transmitted from the medical institution; and
a controlling part for controlling operations of said condition examining part, said medical information converting part, and said local wireless interface for medical terminal.

2. The medical terminal as stated in claim 1, wherein said local wireless interfaces with the wireless terminal, and said medical terminal is one selected from a group consisting of BlueTooth, IEEE 802.11, IrDA, and Home RF.

3. The medical terminal as stated in claim 1, wherein said condition examining part is one selected from a group consisting of a blood pressure monitor, a thermometer, a heart rate monitor, a diabetes monitor, a blood flow monitor, a blood glucose monitor, and an atmosphere monitor.

4. A wireless terminal for remote access examination in a portable medical system that communicates medical information between said wireless terminal and a medical terminal by wireless, said wireless terminal comprising:
an input part for receiving information from a user;
an output part for displaying selected information to be perceived by the user;
a local wireless interface for wireless terminal to receive medical information via a local wireless interface for the portable medical system;
an RF converting part for converting medical information into an RF signal for wireless communication;
an RF transducer for transmitting the RF signal to a predetermined medical institution and for receiving medical result information from the medical institution;
a memory for storing selected information; and
a controlling part for controlling operations of said input part, said output part, said local wireless interface for wireless terminal, and said RF transducer.

5. A remote medical system comprising:
a medical terminal for examining a condition of user's health to produce medical information; and
a wireless terminal for transmitting medical information received from said medical terminal to a predetermined medical institution and for receiving medical result information from the medical institution,
wherein said medical terminal comprises:
a condition examining part for examining the condition of user's health;
a medical information converting part for converting condition information produced by said condition examining part into medical information that can be perceived by the outside world;
a local wireless interface for medical terminal for transmitting medical information to the local wireless interface of the wireless terminal, such that medical information is transmitted to a medical institution and medical result information is transmitted from the medical institution; and
a controlling part for controlling operations of said condition examining part, said medical information converting part, and said local wireless interface for medical terminal,
wherein said wireless terminal comprises:
an input part for receiving information from the user;
an output part for displaying selected information to be perceived by the user;
a local wireless interface for wireless terminal to receive medical information via a local wireless interface for the portable medical system;
an RF converting part for converting medical information into an RF signal for wireless communication;
an RF transducer for transmitting the RF signal to the medical institution and for receiving medical result information from the medical institution;
a memory for storing selected information; and
a controlling part for controlling operations of said input part, said output part, said local wireless interface for wireless terminal, and said RF transducer.

6. A method for processing medical information by using a wireless terminal and a medical terminal both having local wireless interfaces, said method comprising the steps of:
examining a condition of user's health;
converting condition information related to the condition of user's health into medical information that can be perceived by the outside world; and
transmitting the medical information to the local wireless interface for wireless terminal through the local wireless interface for medical terminal for the purpose of transmitting the medical information from the wireless terminal to a predetermined medical institution and receiving medical result information from the medical institution.

7. A method for processing medical information by using a wireless terminal and a medical terminal both having local wireless interfaces, said method comprising the steps of:
receiving medical information provided through a local wireless interface for medical terminal;
converting medical information into an RF signal for wireless communication;
transmitting the RF signal to a predetermined medical institution through a wireless network; and
displaying medical result information received from the medical institution for a user to perceive.

8. A method for processing medical information in a remote access medical system provided with a wireless terminal and a medical terminal both having local wireless interfaces, said method comprising the steps of:
examining a condition of user's health;
converting condition information related to the condition of user's health into medical information that can be perceived by the outside world;
transmitting medical information to the local wireless interface for wireless terminal through the local wireless interface for medical terminal for the purpose of transmitting medical information from the wireless terminal to a predetermined medical institution and receiving medical result information from the medical institution;
receiving medical information provided through a local wireless interface for medical terminal;
converting medical information into an RF signal for wireless communication;
transmitting the RF signal to a predetermined medical institution through a wireless network; and
displaying the medical result information received from the medical institution for a user to perceive.
